(19) United States
(12) Patent Application Publication
(10) Pub. No.: US 2014/0052655 A1
(43) Pub. Date: Feb. 20, 2014

(54) Sponsor Assignment

(71) Applicant: SOLAVEI, LLC, Bellevue, WA (US)

(72) Inventors: Ryan K. Wuerch, Medina, WA (US); James P. Ryan, Bellevue, WA (US)

(73) Assignee: SOLAVEI, LLC, Bellevue, WA (US)

(21) Appl. No.: 13/827,344

(22) Filed: Mar. 14, 2013

Related U.S. Application Data
(60) Provisional application No. 61/683,463, filed on Aug. 15, 2012.

(51) Int. Cl. G06Q 50/00; G06Q 30/00

(52) U.S. Cl. CPC G06Q 50/01; G06Q 30/00
USPC 705/319

(57) ABSTRACT

The present application describes methods, systems, and apparatuses for assigning sponsors to a new member of a commerce platform. One or more of a plurality of existing members of the commerce platform with connections to a new member are identified. The social commerce platform is configured to cause display, on a device associated with the new member, a list of the one or more of the plurality of existing members to enable selection of one of the existing members in whose network within the commerce platform the new member will participate. The social commerce platform is configured to select one of the existing members in whose network within the commerce platform the new member will participate based at least on relative strengths of the connections.

### RELATED APPLICATIONS

This application claims priority to U.S. Provisional App. No. 61/683,463, filed Aug. 15, 2012 and entitled “Sponsor Assignment,” the entire contents of which are hereby incorporated herein by reference in their entirety.

### BACKGROUND

In a conventional multi-level marketing or direct sales arrangement, a member markets and sells goods to their social contacts, including friends, family, and other people that they come into contact with, either online or face-to-face. The multi-level marketer also recruits their social contacts to participate in the organization as a new member, who markets and sells goods to their own social contacts. The new member is assigned to participate within the network of the person that recruited them. The person that recruited them may also profit from the sales efforts of his or her network members, and therefore has an incentive to assist the new member in his or her marketing efforts.

### BRIEF DESCRIPTION OF THE DRAWINGS

The following description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example environment suitable for providing a sponsor assignment service.

FIGS. 2-5 illustrate example web interfaces for facilitating a user-interactive sponsor assignment processes.

FIGS. 6A-D and 7A-C illustrate example mobile interfaces for facilitating user-interactive sponsor assignment processes.

FIG. 8 is a flow chart that illustrates an example process for assigning a sponsor to a new member for whom an inviting sponsor is unknown.

FIG. 9 is a flow chart that illustrates an example process for assigning a sponsor to a new member when an identity of an inviting sponsor is not known, or when there is no inviting sponsor.

FIG. 10 is a flow chart that illustrates an example process for automatically assigning a sponsor to a new member.

FIG. 11 is a flow chart that illustrates an example process for randomly assigning a sponsor to a new member.

FIG. 12 is a block diagram of an example computing system usable to provide the social commerce platform.

### DESCRIPTION OF THE FIGURES

Embodiments of the present disclosure include a sponsor assignment service. The sponsor assignment service may be related to a social commerce system that enables a social commerce community. A social commerce community may include members or entities that participate in the social commerce system. In one example, a social commerce community may be a community of members who have signed up for a service, such as a mobile phone service, an energy service, a cable service, or other service. The members may also participate in both offline and e-commerce activities that involve buying and selling of goods, buying electronic media, and so forth. The members have the opportunity to recruit additional members into the community. The recruited members become part of the member's network, and the member may be compensated based on the number of members (service subscribers) within his or her network, and may be compensated for other activities of the members in their networks, such as purchases made by the members within their network.

A member's sponsor is another social commerce participant/member who is directly above the member within the social commerce community. The sponsor acts as the new member's primary relationship within the social commerce community. The sponsor helps the new member become oriented, points them towards opportunities to obtain new members, coaches them on making contacts with prospective members, helps them understand the compensation scheme of the social commerce community, assists them with navigating through the social commerce online systems, and so forth. Thus, identifying a good sponsor match for a new member can be an important factor that determines whether the new member achieves success within the social commerce community.

During a membership activation process, a sponsor is assigned to the new member. In many instances, the person who directly recruited a new member becomes the new member's sponsor. But it is not always clear which member should be a new member's sponsor. Embodiments of the present disclosure include systems and methods for assigning a sponsor to a new member.

A wide range of criteria may be used by an automated and intelligent system to aid in the assignment process and put forth sponsor recommendations to the new member. For example, existing relationships, new member location, new member interests, and so forth may be used to match the new member to a sponsor with the same or complimentary relationships, location, and interests. In various embodiments, these various criteria may be used to identify and tentatively assign a sponsor to a new member. In embodiments, a sponsor is assigned to a new member based on the strength of the sponsor's connections to the new member, such as may be determined from sales outreach activities of the sponsor or the sponsor's social network connections, or based on other criteria. In some embodiments, the ultimate decision of sponsor assignment rests with the new member. Allowing a new member to select (or reject) his or her sponsor may act as a safety valve in case the new member is assigned to a sponsor with whom the new member does not wish to work for some reason. Embodiments include interactive processes that enable a new member to select a sponsor. The sponsor assignment may be carried out interactively by the new member or by an existing member on behalf of prospective/new members via the web and via a personal computer or mobile phone.

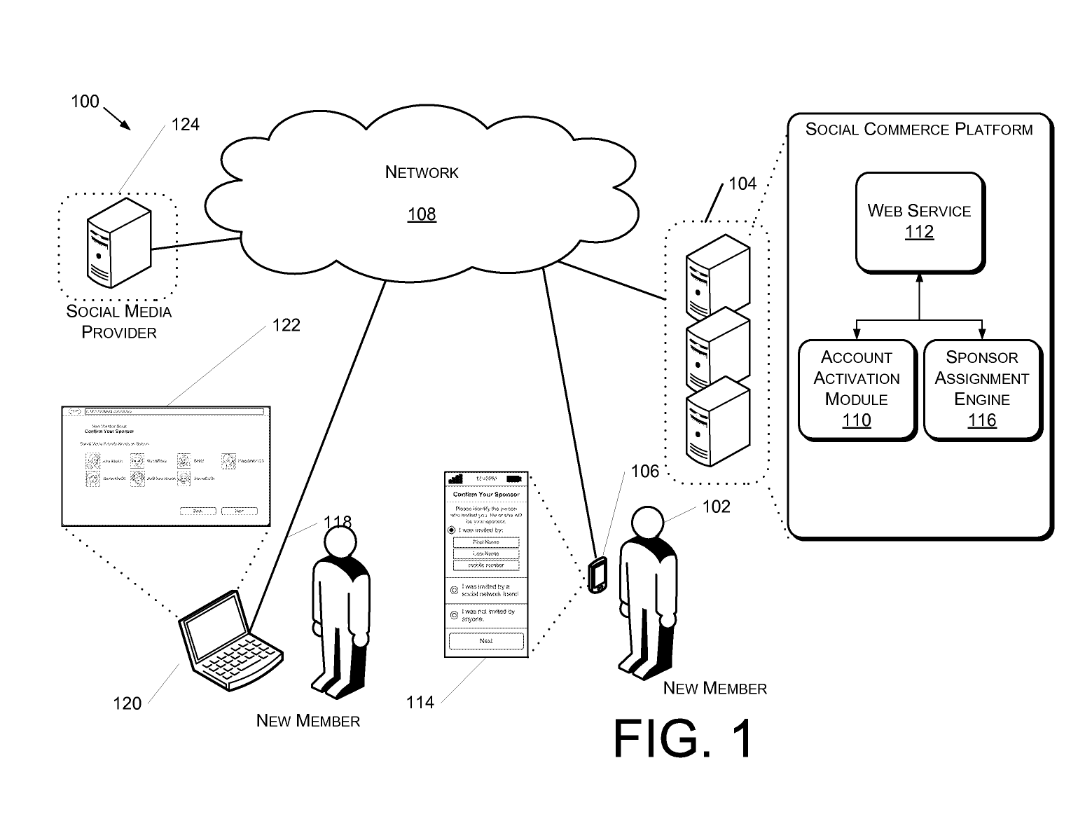

FIG. 1 illustrates an example environment 100 suitable for providing a sponsor assignment service. A new member 102 accesses a social commerce platform 104 using a mobile device 106 via a network 108. The mobile device 106 may include a web browser or one or more applications for accessing an account activation module 110, such as via a web service 112. The account activation module 110 and/or the web service 112 may cause the mobile device 106 to display interface 114, which is interactive to allow the new member 102 to establish his or her member account within the social commerce platform 104. For example, the interface 114 may include fields for entering the new member's address, home phone number, social media information, a username, a password, and so forth.

Additionally, the interface 114 may include one or more options to enable the new member 102 to select and/or confirm a sponsor to be assigned to the new member 102. The sponsor assignment engine 116 utilizes various criteria or intelligence information—such as member interests, location, pre-existing relationships, and so forth—to put forth sponsor recommendations. The sponsor assignment engine 116 also executes one or more interactive processes that enable the new member 102, via the interface 114, to confirm and/or select a sponsor for him or herself

Similarly, new member 118 may access the social commerce platform 104 using personal computer 120 to engage in the new member activation process. One or more of the web service 112, the account activation module 110, and the sponsor assignment engine 116 cause the personal computer 120 to display interface 122. The interface 122 displays various fields for entering the new member's address, home phone number, social media information, a username, a password, and so forth. Additionally, the interface 122 may include one or more options to enable the new member 118 to select and/or confirm a sponsor to be assigned to the new member 118.

Environment 100 also includes social media provider 124. The social commerce platform 104, and in particular the sponsor assignment engine 116, may retrieve from the social media provider 124 social media information regarding existing and new members, including for example social network connections of the existing and new members, social network messages sent and received, social network postings, photograph tags, status changes/updates, and so forth. The sponsor assignment engine 116 may use some or all of the retrieved social media information to perform sponsor assignment. The social media information may be stored in the user data, including the sales tracker data, of the existing and new members. In some embodiments, some or all of the social media information may be retrieved in real-time from the social media provider 124, without storing the information in the user data. The existing and new members may provide their social media credentials (e.g., username and password), thereby enabling the social commerce platform 104 to retrieve the information from the social media provider 124. Information from more than one social media provider 124 may be retrieved, stored, and used to perform sponsor assignment.

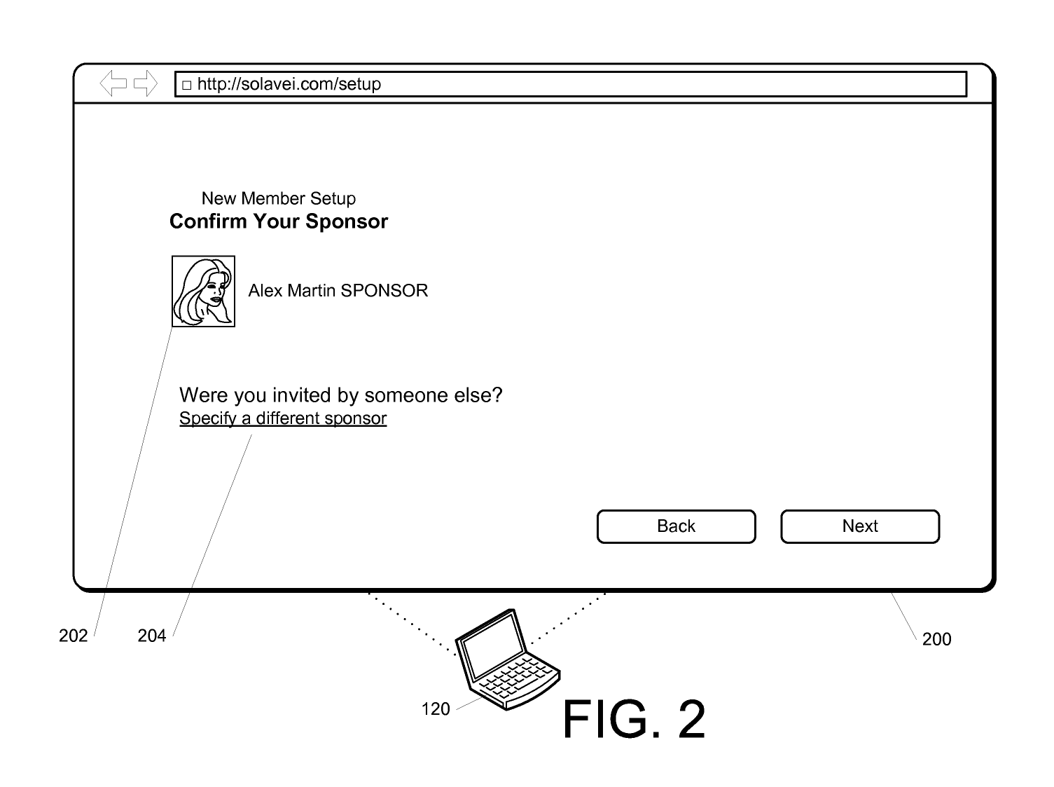

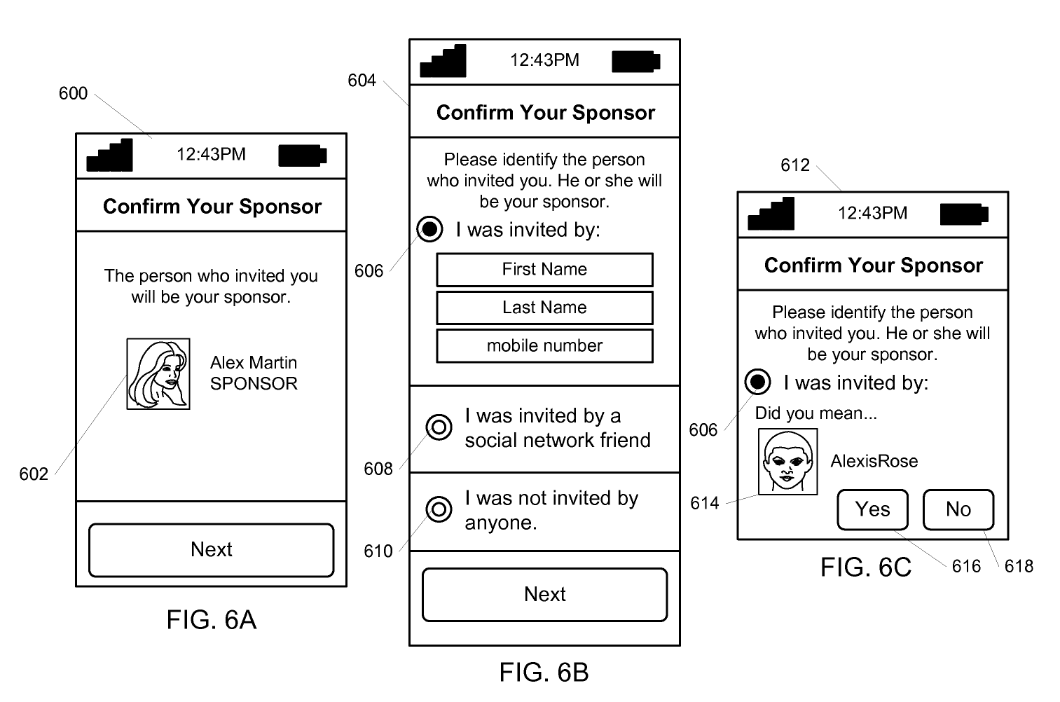

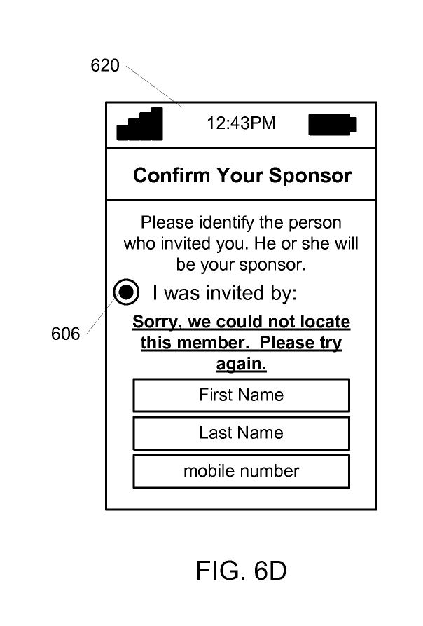

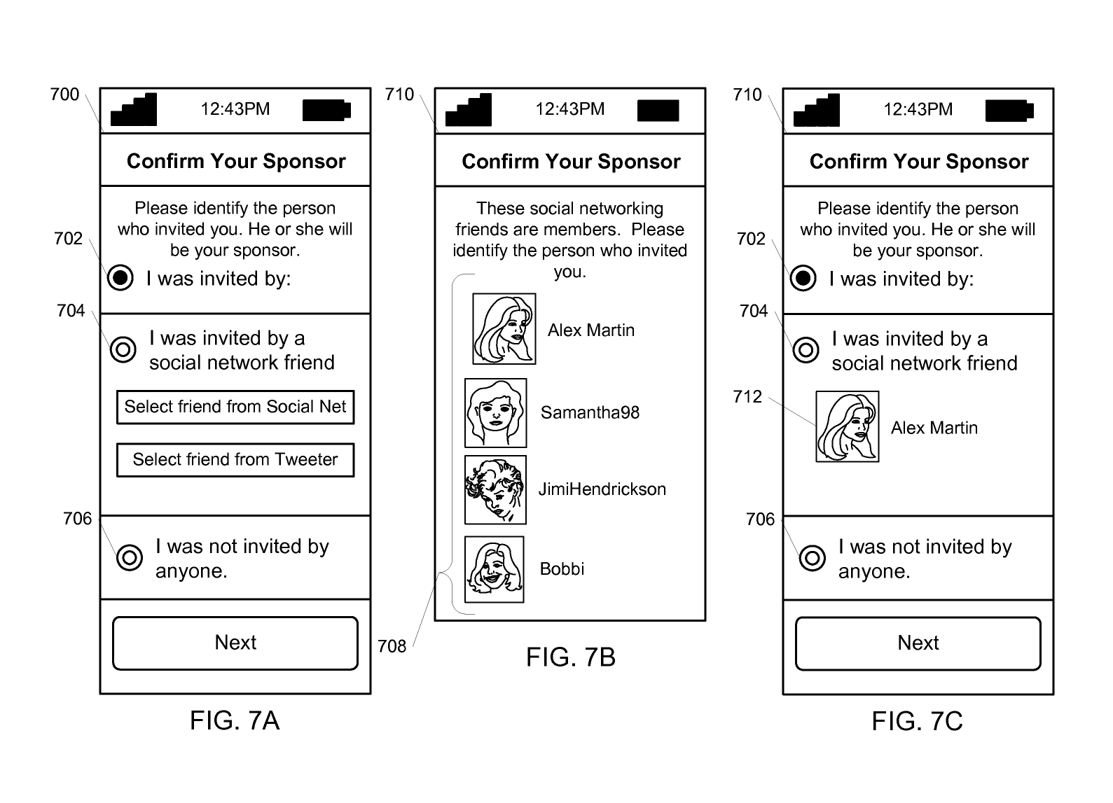

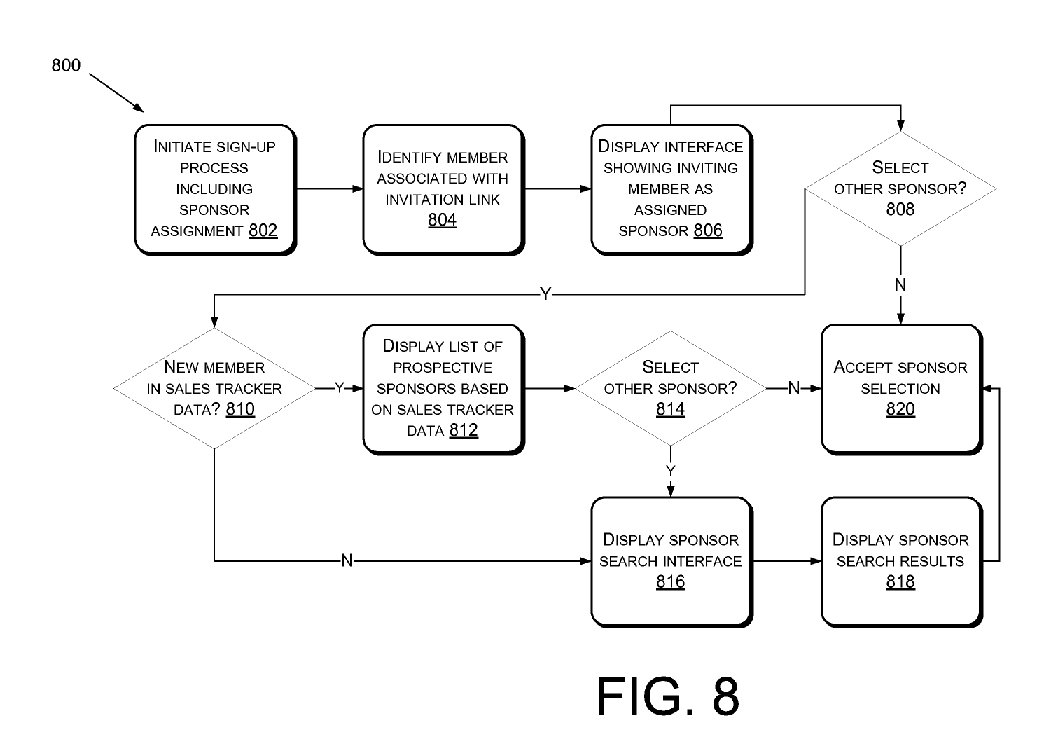

FIGS. 2-5 illustrate example web interfaces for facilitating a user-interactive sponsor assignment processes. FIGS. 6 and 7 illustrate example mobile interfaces for facilitating user-interactive sponsor assignment processes. FIGS. 2-7 will be described with reference to the flow charts in FIGS. 8-11. FIGS. 8-11 depict flow charts that show example processes in accordance with various embodiments. The operations of these processes are illustrated in individual blocks and summarized with reference to those blocks. These processes are illustrated as logical flow graphs, each operation of which may represent a set of operations that can be implemented in hardware, software, or a combination thereof. In the context of software, the operations represent instructions, such as computer-executable instructions, stored on one or more computer-readable storage media that are executable by one or more processors to enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be combined in any order, separated into sub-operations, and/or performed in parallel to implement the process. Processes according to various embodiments of the present disclosure may include only some or all of the operations depicted in the logical flow graphs.

### Inviting Sponsor Known

In embodiments, the inviting sponsor may be known, such as when a new member may be enrolled via an invitation link provided by a particular candidate sponsor. The link may have been provided to the new member by the particular candidate sponsor via an email, a text message, an instant message, a social networking message, on a personal website of the candidate sponsor, or in some other fashion. The link may have information that allows the sponsor assignment engine to identify the candidate sponsor.

FIG. 8 is a flow chart that illustrates an example process 800 for assigning a sponsor to a new member for whom an inviting sponsor is known. At 802, an account activation module, such as the account activation module 110 of the social commerce platform 104, initiates a sign-up process to enable a new member to join the social commerce platform. This includes, for example, providing various sign-up user interfaces, such as via the web service 112, to a user device, such as the mobile device 106 and the personal computer 120. The new member may enter various data about him or herself, such as address, current telephone number, and so forth. At some point in the sign-up process, a sponsor assignment begins.

At 804, the sponsor assignment engine identifies the member associated with the invitation link. At 806, the sponsor assignment engine causes an interface, such as the interface 200 shown in FIG. 2 or the mobile interface 600 shown in FIG. 6A, to be displayed that shows the identified member 202 or 602 as a candidate sponsor. In the example shown in FIG. 2 and FIG. 6A, Alex Martin is the candidate sponsor. An option, such as the option 204, to select a different sponsor is displayed in some embodiments. For example, the option 204 may be displayed if the new member clicks on the invitation link within a grace period (e.g., the first 5 days after enrollment).

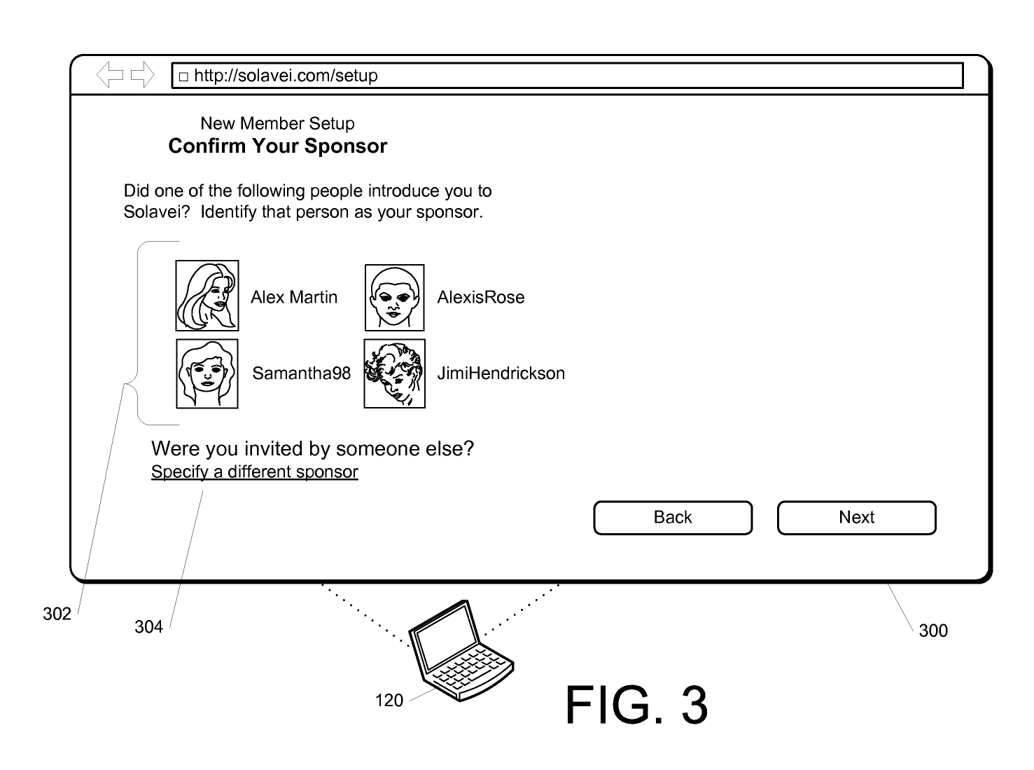

If the new member selects the option 204, at 808, then at 810 the sponsor assignment engine checks if the new member is found in any existing members' sales tracker data. The sales tracker data includes sales activity data of members participating in the social commerce community, including sales outreach activity such as sending emails, social networking messages, instant messages, placing or receiving phone calls to prospective members, text messages, video calls, and so forth. In the same or different embodiments, the sponsor assignment engine determines whether any existing members have social network connections to the new member. If one or more members have the new member in their sales tracker data, and/or if any of the members have social network connections to the new member, then at 812 an interface, such as the interface 300 illustrated in FIG. 3, is displayed to show the one or more members. A comparable mobile interface may also be displayed on mobile device 106 in various embodiments. The interface 300 includes icons identifying the one or more members 302 with social network connections to the new member, and the new member may select one of the members 302 to be his or her sponsor. The new member may also select at 814 an option, such as option 304, to select none of the one or more members 302.

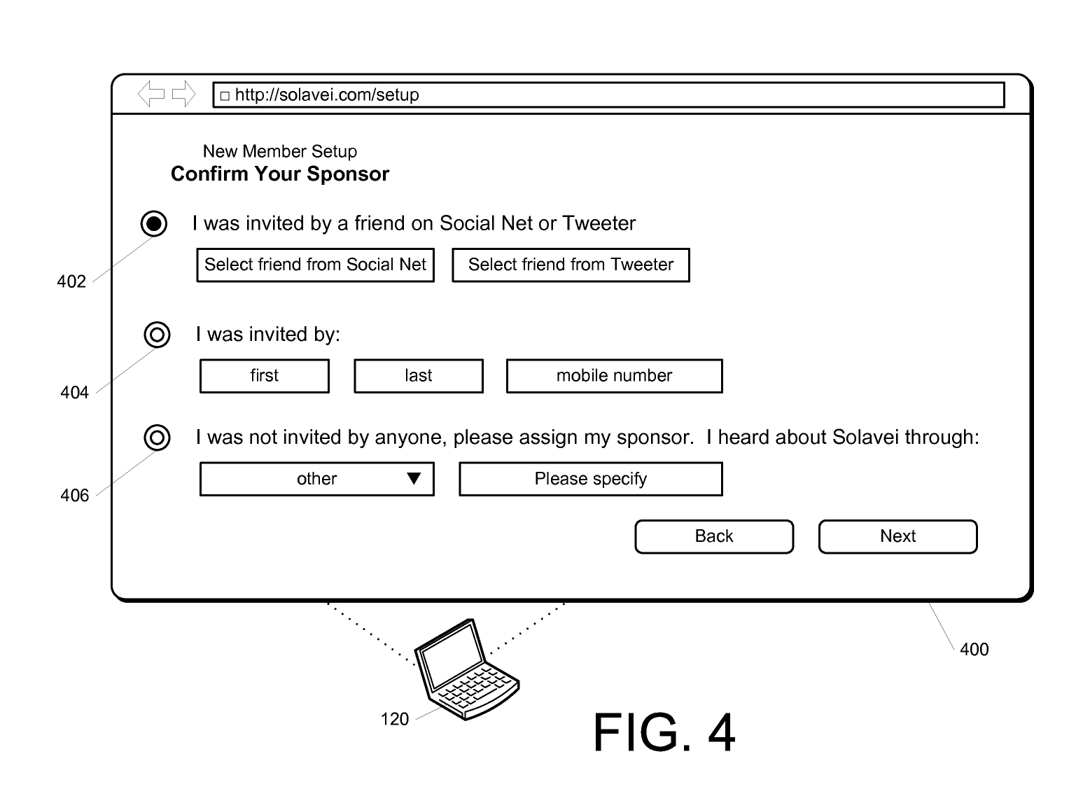

If no members have the new member in their sales tracker data, none of the members have existing social network connections to the new member, and/or the new member selects an option to choose none of the members identified, then at 816 the sponsor assignment engine 116 displays an interface, such as the interface 400 illustrated in FIG. 4 or the interface shown in FIG. 7A, with various selectable options to search for a sponsor. For example, interface 400 includes selectable option 402 to search for a social media contact—such as a contact on a social media provider 124—who is also a member of the social commerce community to be the new member's sponsor. This can be useful, for example, where the sales tracker data does not indicate the social network connection between an existing member and the new member. Selectable option 404 enables the new member to enter the name and/or phone number of a member that invited them or whom they believe to be a member of the social commerce community. Selectable option 406 enables the new member to request that a sponsor be selected for them.

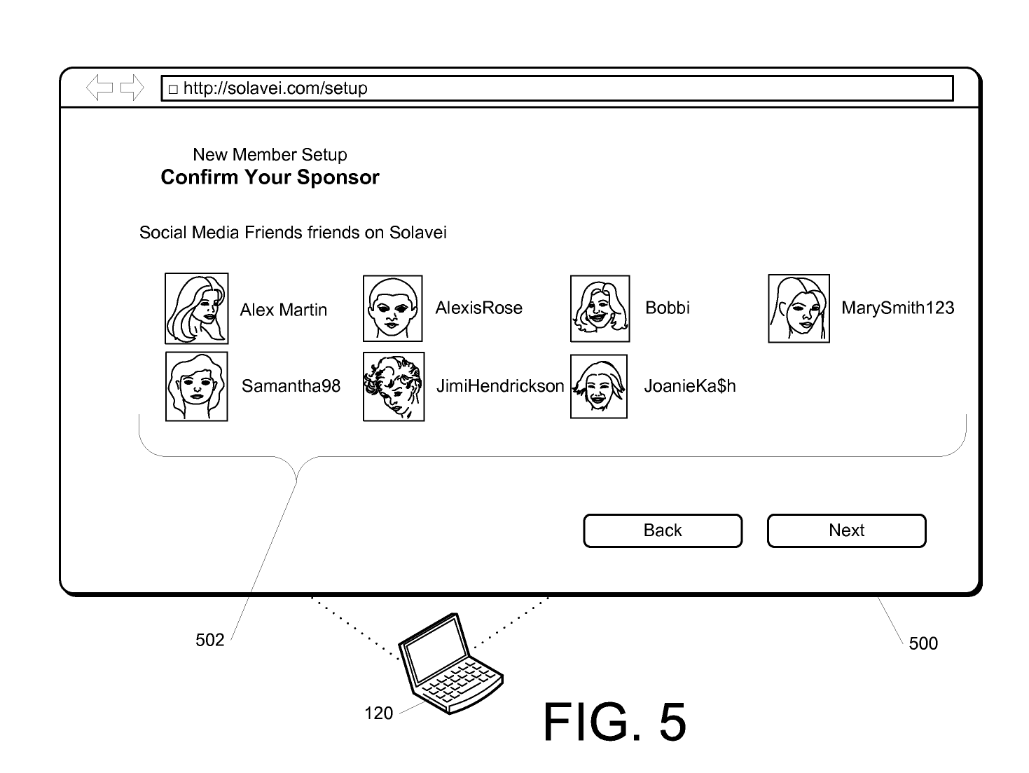

At 818, the sponsor assignment engine 116 causes a list of sponsor search results based on the input entered by the new member in interface 400. For example, the interface 500 of FIG. 5 shows a list of sponsor search results 502 who are also the new member's social media contacts from which the new member may select a sponsor. In another example, interface 7B shows a list of sponsor search results 708 who are also the new member's social media contacts from which the new member may select a sponsor.

At 820, the new member's sponsor selection is accepted and the sponsor is assigned to the new member.

The mobile interfaces illustrated in FIGS. 6B-D include example mobile interfaces for sponsor assignment where the new member was invited by an existing member, but the inviting member has not been tracked. The interface 604 in FIG. 6B enables the new member to specify a person that invited them, such as via option 606 to search by name and/or mobile telephone number and option 608 to search for social network contacts. Option 610 enables the new member to indicate that they were not invited by anyone, and thus need to have a sponsor assigned to them. The interface 612 in FIG. 6C is displayed when the new member's input into the interface 604 in FIG. 6B matches a member 614 in the social commerce community, along with selectable options 616 and 618 to confirm or reject the member 614. The interface 620 shown in FIG. 6D is displayed when the new member's input into the interface 604 in FIG. 6B matches no members in the social commerce community.

### Inviting Sponsor Not Known

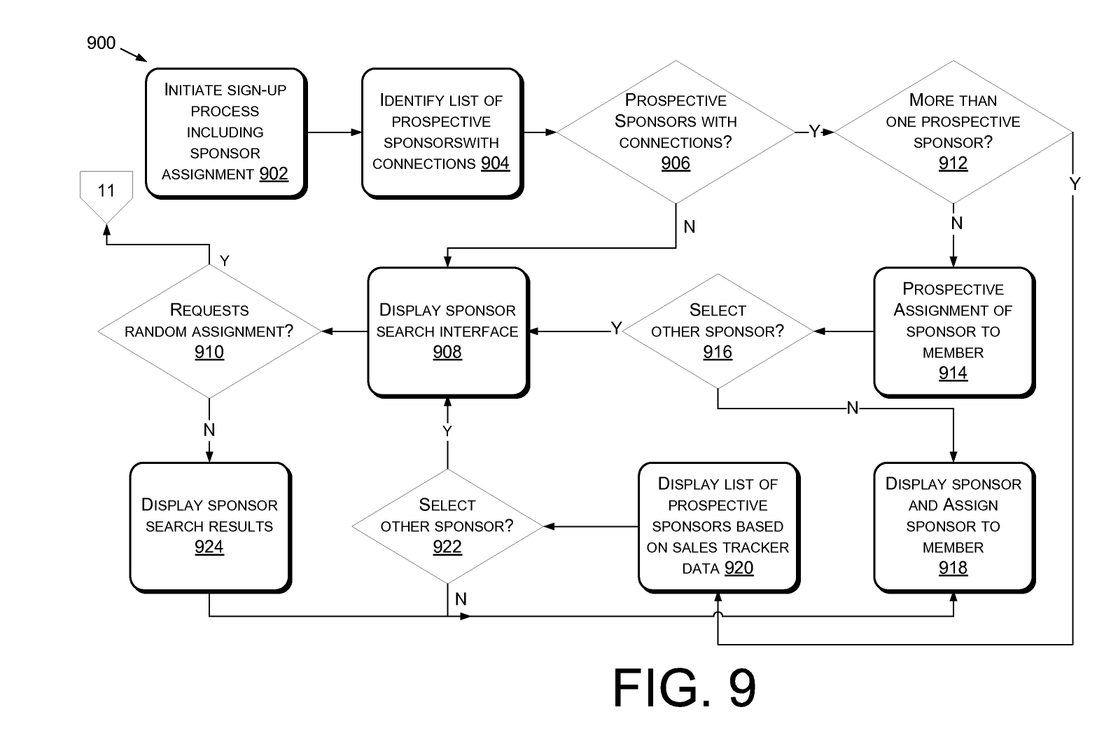

FIG. 9 is a flow chart that illustrates an example process 900 for assigning a sponsor to a new member when an identity of an inviting sponsor is not known, or when there is no inviting sponsor. The inviting sponsor may be unknown, for example, when the new member reaches an enrollment interface directly from a marketing website, and not via an invitation link from a specific member as is described with respect to FIG. 8. Process 900 may be used in all new member enrollments where the inviting sponsor is not known, or only in some cases, such as or during an initial grace period after the initial enrollment by the new member, such as for example prior to the expiration of a predetermined amount of time or a grace period, such as during the first five days of new member enrollment or other time period.

At 902, an account activation module, such as the account activation module 110 of the social commerce platform 104, initiates a sign-up process to enable a new member to join a social commerce platform. This includes, for example, providing various sign-up user interfaces, such as via the web service 112, to a user device, such as the mobile device 106 or the personal computer 120. The new member may enter various data about him or herself, such as address, current telephone number, and so forth. At some point in the sign-up process a sponsor assignment begins.

At 904, the sponsor assignment engine 116 identifies a list of prospective sponsors with connections to the new member, such as based on a search of the sales tracker data as described above. The sales tracker data may include sales outreach activities directed to the new member, social network connection data regarding the new member, a number of invitations to join the social commerce platform sent to the new member, or other data.

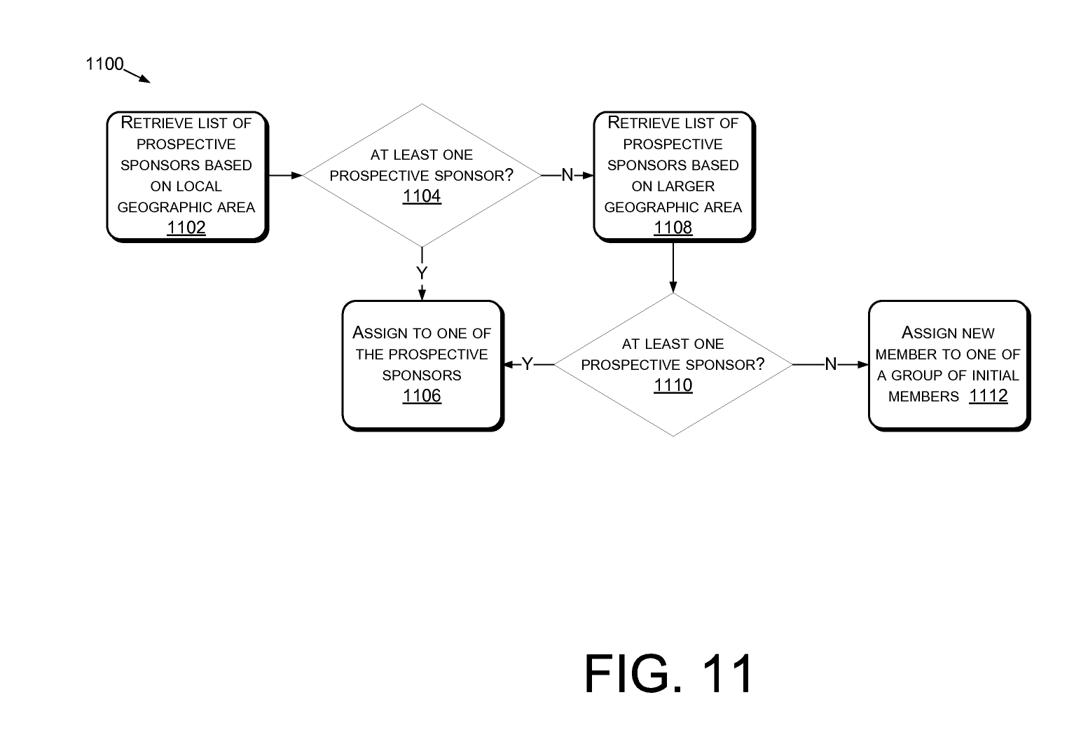

If no prospective sponsors have connections to the new member at 906, then the sponsor assignment engine 116 causes a sponsor search interface, such as the interface 400 of FIG. 4 or the interface 700 in FIG. 7A, to be displayed at 908. If the new member selects an option, such as the option 406, to have a random sponsor assigned to him or her, at 910, then a sponsor is selected according to a protocol, such as is described with reference to FIG. 11.

If only one member has a connection to the new member at 912, then that member is assigned or tentatively assigned to be the new member's sponsor and an interface, such as the interface 200 of FIG. 2, is displayed showing the prospective selection of the sponsor 202 at 914. An option, such as the “specify a different sponsor” option 204, may be displayed as well, such as if a grace period (such as a five day grace period) has not lapsed. If the new member selects an option, such as the option 204, to select a different sponsor at 916, then an interface, such as the interface 400 of FIG. 4 or the interface 700 in FIG. 7A, showing sponsor search options 702, 704, and 706 is displayed at 908. Search option 702 enables the new member to enter the name and/or phone number of the inviting member, and is the same as or similar to search option 606 of FIG. 6B. Search option 704 enables the new member to select a friend from a social networking site, and is the same as or similar to search option 608 of FIG. 6B. Search option 706 enables the new member to indicate that he or she was not invited by anyone, and thus initiating an automated sponsor assignment, and is the same as or similar to search option 610. Otherwise, the sponsor assignment engine 116 assigns the selected sponsor to the new member at 918.

If more than one member has a connection to the new member at 912, then the sponsor assignment engine causes an interface, such as the interface 300 of FIG. 3, to be displayed to show the list of members as prospective sponsors at 920. If the new member selects an option, such as the option 304, to specify a different sponsor at 922, then an interface, such as the interface 400 of FIG. 4 or the interface 700 in FIG. 7A, showing sponsor search options 702, 704, and 706 is displayed at 908.

At 924, the sponsor assignment engine 116 causes sponsor search results 502 or 708, such as in the interface 500 or the interface 710 in FIG. 7B, to be displayed. The new member can select one of the identified members, such as sponsor search results 502 and 708, to be his or her assigned sponsor. Once one of the sponsor search results 502 or 708 are selected, the selected sponsor may be displayed for further confirmation, such as in interface 710 of FIG. 7C, which displays selected sponsor 712 and enables the new member to confirm the selection.

### Automated Sponsor Assignment

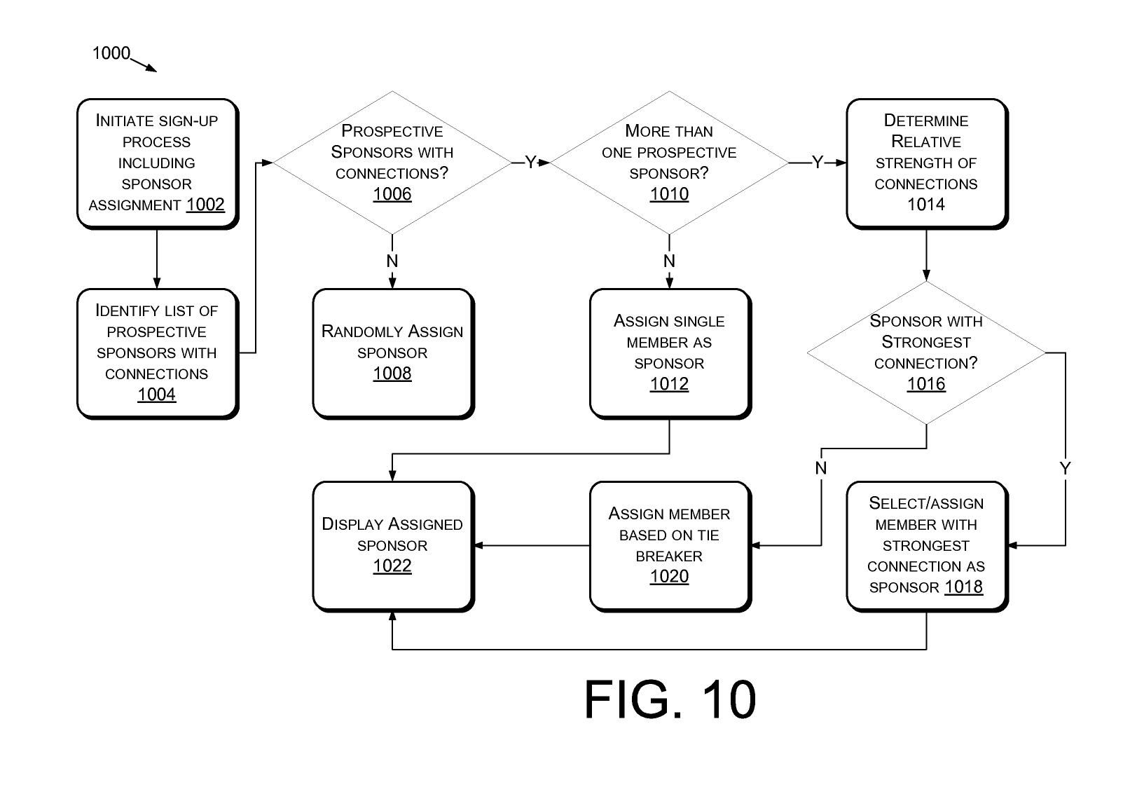

FIG. 10 is a flow chart that illustrates an example process 1000 for automatically assigning a sponsor to a new member. Automatic assignment of a sponsor may occur in all new member enrollments where there are existing members with connections to the new member, or only in some new member enrollments, such as after a predetermined amount of time, such as a grace period, has expired following the initial enrollment of the new member. An example grace period may be five days, although another grace period may be used without departing from the scope of the present disclosure. Thus, a new member may be given the opportunity to select their own sponsor, such as is described in FIG. 9, during the grace period, but a new member may have a sponsor assigned to them automatically after the grace period expires if the new member has not selected their own sponsor.

At 1002, an account activation module, such as the account activation module 110 of the social commerce platform 104, initiates a sign-up process to enable a new member to join a social commerce platform. This includes, for example, providing various sign-up user interfaces, such as via the web service 112, to a user device, such as the mobile device 106 or the personal computer 120. The new member may enter various data about him or herself, such as address, current telephone number, and so forth. At some point in the sign-up process a sponsor assignment begins.

At 1004, the sponsor assignment engine 116 identifies a list of prospective sponsors that have connections to the new member. This may include, for example, searching whether the new member's name is found in any existing members' sales tracker data (thereby indicating sales outreach activities with respect to the new member), social network connection data regarding the new member, or other data.

If the sales tracker data indicates that no members have connections to the new member at 1006, then, at 1008, the sponsor assignment module 116 may assign a random sponsor such as is described with reference to FIG. 11.

If only one existing member has a connection to the new member, such as for example if the new member's name appears in a single member's sales tracker data at 1010, then at 1012 the sponsor assignment module 116 automatically assigns the single existing member with a connection to the new member to be the new member's sponsor and causes an interface, such as the interface 200, to be displayed showing the selected sponsor. No option, such as the option 204, to enable the new member to reject the selected sponsor is displayed.

If multiple existing members have connections to the new member, such as if the new member appears in multiple members' sales tracker data at 1010, then at 1014 the sponsor assignment engine 116 determines relative strengths of the prospective sponsor's connections to the new member. The relative strengths of the connections may be based, in embodiments, on the sales outreach activities of the prospective sponsors with respect to the new member.

The sales outreach activities may include one or more of emails sent to the new member, instant messages sent to the new member, phone calls made to the new member, chat sessions initiated with the new member, text messages sent to the new member, social networking messages sent to the new member, video calls made to the new member, and so forth. The relative strengths of the connections may be based on a number of the outreach activities performed by corresponding ones of the plurality of the existing members with respect to the new member. For example, if one of the members has more sales outreach activities related to the new member than the other identified members, then that member would have a greater relative strength of connection than the other members.

In some embodiments, the relative strengths of the connections are determined based on a weighted formula of the outreach activities, with different weights are applied to different types of outreach activities. For example, phone calls made to the new member may be weighted more heavily than emails to the new member, social networking messages may be weighted less heavily than text messages sent to the new member's mobile phone, and so forth.

In embodiments, the relative strengths of the connections may be based, in embodiments, on strengths of the social network connections—such as on an online social network including but not limited to Facebook® or other online social network—between the new member and the prospective members. The strengths of social network connections may be based on based at least on whether the existing members have direct connections to the new member (e.g., are “friends” or “followers” of the new members in the social network), one or more of a number of social network interactions (such as messages, postings, photo tags, etc.) between ones of the plurality of the existing members and the new member, a degree of social network separation between the ones of the plurality of the existing members and the new member (such as based on the smallest number of social network contacts that you can go through to link an existing member to the new member), and a number of common social network connections shared between the ones of the plurality of the existing members and the new member (e.g., the number of “friends” in common).

In still further embodiments, some combination of sales outreach activities and social network connections may be used to determine relative strength of connection. For example, a weighted formula may be used to weigh sales outreach activities (such as for example as described above) and various aspects of the existing members' social network connections to the new member. In other embodiments, one or the other may be used as a tie-breaker. For example, where two or more of the prospective sponsors have the same determined relative strength of connection to the new member based on sales outreach activity, strength of social network connections may be used as a tie-breaker, and vice versa.

At 1016, the sponsor assignment module 116 determines whether there is a “winner” among the list of prospective sponsors, based on the relative strengths of the prospective sponsors.

At 1018, the sponsor assignment module 116 may select or assign as sponsor the member with the strongest connection to the new member. If the amount of activity is equal between two or more members, then the sponsor assignment module 116 at 1020 may assign a sponsor using some tie-breaker, such as alphabetically, based on member number, based on strength of social network connections, or in some other fashion. At 1022, the selected sponsor is shown in an interface, such as interface 200, but without an option, such as the option 204, to reject the selected sponsor.

### Random sponsor assignment

In various embodiments, the sponsor assignment engine 116 may “randomly” assign a sponsor to an “orphaned” member. A new member may be orphaned, where there are no existing members with connections to the new member and where the new member chooses not to search for a sponsor. FIG. 11 is a flow chart that illustrates an example process 1100 for randomly assigning a sponsor to a new member. At 1102, the sponsor assignment engine 116 may retrieve a list of prospective sponsors. In embodiments, the prospective sponsors include members who are in the same local geographic area (such as the same city, ZIP, or other postal code) as the new member and who have obtained at least a certain minimal rank within the social commerce community. (Rank may be based on, for example, an amount of sales activity or number of members within a member's network.)

At 1104, if there is at least one prospective sponsor that meets the criteria, then at 1106, the sponsor assignment engine 116 assigns the orphaned member to one of the prospective sponsors.

If no prospective sponsors of the at least minimal rank are located in the same local geographic area as the new member, then at 1108 the sponsor assignment engine 116 retrieves a list of prospective sponsors that have achieved at least a minimal rank and who are located in the same larger geographic area, such as the same county, state, province, or country, as the new member. The sponsor assignment engine 116 assigns one of the prospective sponsors to the new member.

At 1110, if no prospective sponsor with the minimal rank is found in the same geographic area as the new member, then at 1112 the sponsor assignment engine 116 assigns the new member to one of a group of initial members, such as a group of 100-200 initial members or other number of members, of the social commerce community. These members are the first members to have joined the social commerce community.

When selecting a sponsor from any group of prospective sponsors during an orphan assignment process (whether the group is identified based on city, ZIP code, county, state, province, country, initial group of sponsors, or other criteria), the orphan assignment engine 116 assigns orphans amongst the prospective sponsors evenly so that no sponsor is assigned an X^{th} orphan until all prospective sponsors in the group have been assigned at least X−1 number of orphans. For example, the sponsor assignment engine 116 will not assign a second orphan to a prospective sponsor within a group of prospective sponsors until all prospective sponsors in the same group has been assigned at least one orphaned sponsor.

### Example Computing System

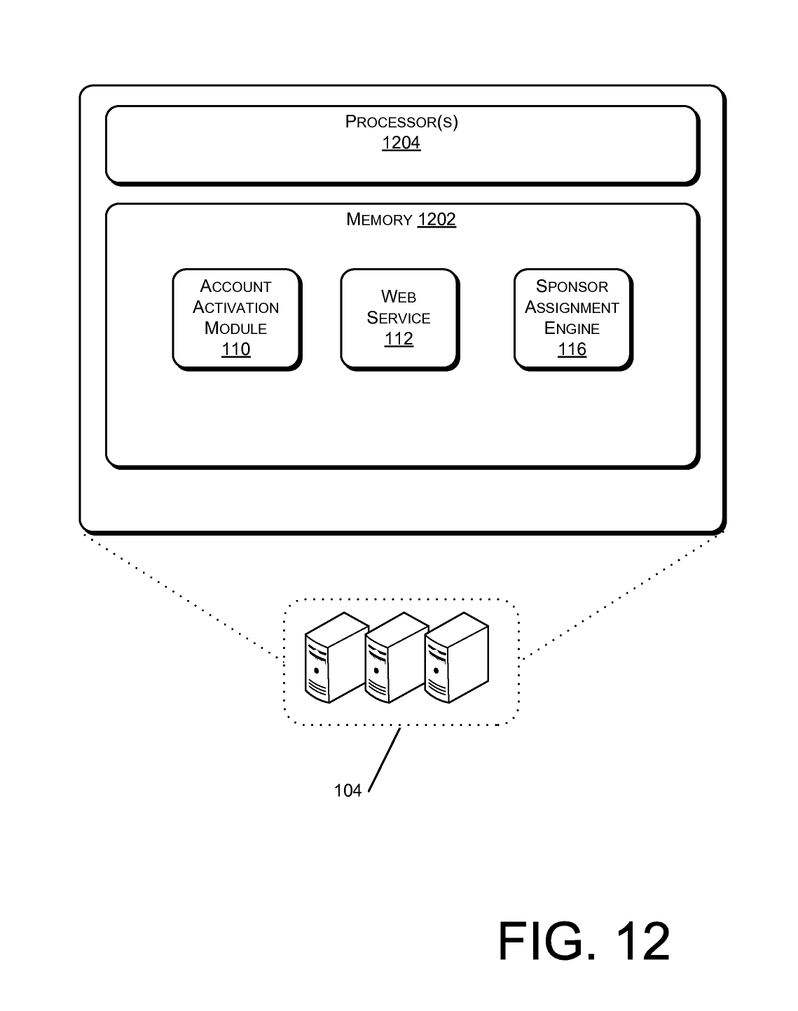

FIG. 12 is a block diagram of an example computing system usable to provide the social commerce platform. The social commerce platform 104 may be configured as any suitable computing device or computing devices capable of implementing service prequalification services. According to various non-limiting examples, suitable computing devices may include or be part of personal computers (PCs), servers, server farms, datacenters, special purpose computers, tablet computers, game consoles, smartphones, media players, combinations of these, or any other computing device(s).

Memory 1202 may store program instructions that are loadable and executable on the processor(s) 1204, as well as data generated during execution of, and/or usable in conjunction with, these programs. For example, the memory 1202 includes the web service 112, the account activation module 110, and the sponsor assignment engine 116.

### Computer-Readable Media

Depending on the configuration and type of computing device used, memory 1202 may include volatile memory (such as random access memory (RAM)) and/or non-volatile memory (such as read-only memory (ROM), flash memory, etc.). Memory 1202 may also include additional removable storage and/or non-removable storage including, but not limited to, flash memory, magnetic storage, optical storage, and/or tape storage that may provide non-volatile storage of computer-readable instructions, data structures, program modules, and other data.

Memory 1202 is an example of computer-readable media. Computer-readable media includes at least two types of computer-readable media, namely computer storage media and communications media.

Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer-readable instructions, data structures, program modules, or other data in a modulated data signal, such as a carrier wave, or other transmission mechanism. As defined herein, computer storage media does not include communication media.

### Conclusion

Although the disclosure uses language that is specific to structural features and/or methodological acts, the invention is not limited to the specific features or acts described. Rather, the specific features and acts are disclosed as illustrative forms of implementing the invention.

We claim:

1. A system, comprising:
one or more processors;
memory storing a plurality of instructions that are executable by the one or more processors to:
identify one or more of a plurality of existing members of a commerce platform with connections to a new member; and
at least one of:
cause display, on a device associated with the new member, a list of the one or more of the plurality of existing members to enable selection of one of the existing members in whose network within the commerce platform the new member will participate; and
select one of the existing members in whose network within the commerce platform the new member will participate based at least on relative strengths of the connections.

2. The system of claim 1, wherein the plurality of programming instructions are further executable to initiate a sign-up process to enable the new member to create an account on the commerce platform.

3. The system of claim 1, wherein the plurality of programming instructions are further executable to identify the one or more of the plurality of members with connections based at least on identification of those existing members with one or more of outreach activities of the plurality of the existing members with respect to the new member and social network connections to the new member.

4. The system of claim 1, wherein the plurality of programming instructions are further executable to cause the display of the list to enable the new member to select the one of the existing members in whose network the new member will participate based on whether a predetermined amount of time has elapsed since the new member first enrolled in the commerce platform.

5. The system of claim 4, wherein the relative strengths of the connections is determined based at least on outreach activities of the plurality of the existing members with respect to the new member.

6. The system of claim 5, wherein the outreach activities includes one or more of emails sent to the new member, instant messages sent to the new member, phone calls made to the new member, chat sessions initiated with the new member, text messages sent to the new member, social networking messages sent to the new member, and video calls made to the new member.

7. The system of claim 5, wherein the plurality of programming instructions are further executable to determine the relative strengths of the connections based on a number of the outreach activities performed by corresponding ones of the plurality of the existing members with respect to the new member.

8. The system of claim 5, wherein the one of the one or more of the plurality of existing members is selected based on the one of the one or more of the plurality of existing members having the most outreach activities with respect to the new member.

9. The system of claim 5, wherein the relative strengths of the connections are determined based on a weighted average of the outreach activities, wherein different weights are applied to different types of outreach activities.

10. The system of claim 4, wherein the plurality of programming instructions are further executable to determine the relative strengths of the connections based at least on strengths of social network connections between the plurality of the existing members and the new member.

11. The system of claim 10, wherein the plurality of programming instructions are further executable to determine the strengths of the social network connections based at least on one or more of a number of social network interactions between ones of the plurality of the existing members and the new member, a degree of social network separation between the ones of the plurality of the existing members and the new member, and a number of common social network connections shared between the ones of the plurality of the existing members and the new member.

12. Computer-readable storage media including a plurality of instructions executable by one or more processors to:
initiate a sign-up process to enable a new member to join a commerce platform;
identify one or more candidate sponsor members from a plurality of members of the commerce platform, the one or more candidate sponsor members having connections to the new member; and
select one of the candidate sponsor members to be a sponsor of the new member, the selection based on relative strengths of the connections.

13. The computer-readable storage media of claim 12, wherein the relative strengths of the connections are based at least on one or more of:
outreach activities of the ones of the plurality of existing members with respect to the new member, and
relative strengths of social network connections with respect to the new member.

14. The computer-readable storage media of claim 13, wherein the one or more outreach activities includes one or more of emails sent to the new member, instant messages sent to the new member, phone calls made to the new member, chat sessions initiated with the new member, text messages sent to the new member, social networking messages sent to the new member, and video calls made to the new member.

15. The computer-readable storage media of claim 13, wherein the relative strengths of the connections are further based on relative numbers of outreach activities of the ones of the plurality of existing members with respect to the new member.

16. The computer-readable storage media of claim 13, wherein the relative strengths of the connections are based on a weighted formula, with different types of outreach activities having different weights.

17. The computer-readable storage media of claim 13, wherein the relative strengths of social connections are determined based at least on one or more of a number of social network interactions between the ones of the plurality of the existing members and the new member, a degree of social network separation between the ones of the plurality of the existing members and the new member, and a number of common social network connections shared between the ones of the plurality of the existing members and the new member.

18. The computer-readable storage media of claim 12, wherein the relative strengths of the connections are based at least on outreach activities of the ones of the plurality of existing members with respect to the new member and relative strengths of social network connections with respect to the new member.

19. A method, comprising:
searching sales tracker data for a list of existing members of a commerce platform that have connections to a new member of the commerce platform;
determining strengths of connections for the list of existing members with respect to the new member; and
selecting one of the list of existing members to be a sponsor of the new member based at least on relative strengths of the connections.

20. The method of claim 19, wherein the determining the strengths of the connections is based at least on outreach activities of the plurality of the existing members with respect to the new member.

21. The method of claim 19, wherein the determining the strengths of the connections is based at least on numbers of outreach activities of the plurality of existing members with respect to the new member.

22. The method of claim 21, wherein the determining the strengths of the connections is based at least further on types of the outreach activities.

23. The method of claim 19, wherein the determining the strengths of the connections is based at least on strengths of social network connections between the list of existing members and the new member.
